(19) United States
(12) Patent Application Publication
(10) Pub. No.: US 2026/0244834 A1
(43) Pub. Date: Aug. 20, 2026

(54) DESIGN METHOD FOR OPTIMIZING TRANSIENT PROCESS PERFORMANCE OF BLADE PUMP

(71) Applicant: Jiangsu University, Jiangsu (CN)

(72) Inventors: Wei LI, Jiangsu (CN); Leilei JI, Jiangsu (CN); Yi YANG, Jiangsu (CN); Haoming LI, Jiangsu (CN); Weidong CAO, Jiangsu (CN); Shuo LI, Jiangsu (CN); Handong QI, Jiangsu (CN)

(73) Assignee: Jiangsu University, Jiangsu (CN)

(21) Appl. No.: 18/842,394

(22) PCT Filed: May 14, 2024
(86) PCT No.: PCT/CN2024/092976

§ 371 Date: Aug. 29, 2024

(30) Foreign Application Priority Data
May 29, 2023 (CN) 202310614852.9

(51) Int. Cl. G06F 30/28

(52) U.S. Cl. CPC G06F 30/28

(57) ABSTRACT

A method for optimizing the transient performance of a blade pump involves creating initial design models for the blade pump and an impeller, as well as a full-flow simulation model for the blade pump startup process. Structural parameters of the impeller are selected as design variables. Based on the initial design model and the full-flow simulation model, transient numerical calculations during the startup process are conducted using CFD simulation software. The transient external characteristics during the startup process include transient head and transient efficiency. The transient head and transient efficiency during the startup process are processed, resulting in weighted average head and weighted average efficiency. The design variables are used as input parameters, with the weighted average head and weighted average efficiency as response values. A transient process performance optimization model is established based on the response surface function and utilized to optimize the transient performance of the blade pump.

### TECHNICAL FIELD

The present disclosure relates to the technical field of fluid machinery, and particularly to a design method for optimizing transient process performance of a blade pump.

### BACKGROUND

In recent years, China has proposed a new scheme in the field of national defense equipment, employing blade pumps as the propulsion device for torpedo launching, which has been applied to the new generation of submarine weapon launching systems. During the launch process, the rotational speed of the blade pump needs to increase from zero to the rated speed in a very short time, and both the head and flow rate must reach the rated values to meet the high-speed water flow required for torpedo ejection, providing sufficient initial kinetic energy for the torpedo. After the torpedo is ejected, the blade pump then goes through a process of deceleration and shutdown, waiting for the next torpedo launch. In this process, the working state of the blade pump to the external is all transient, which is significantly different from the general steady working process. During the startup process, the head, flow rate, and speed all change rapidly, and the flow state also changes quickly, experiencing laminar flow, transition to turbulent flow in a very short time. Many complex flow phenomena exist inside the blade pump during the startup process, including backflow at the inlet and outlet, leakage vortexes generated in the impeller flow passage, separation vortexes, and other complex flow structures such as secondary flows. These phenomena interact with each other, severely affecting the transient efficiency during the pump startup process, causing problems such as low energy conversion rates and insufficient kinetic energy for torpedo ejection. Therefore, to improve the launch effectiveness and accuracy of torpedoes and to enhance national security and development levels, it is necessary to further improve the hydraulic performance and overall efficiency of the blade pump during transient processes.

Internationally, there has been certain theoretical and experimental achievements in the research on the transient characteristics of pumps. Initially, scholars predicted the transient performance of pumps through the quasi-steady-state method. However, it was later discovered in the transient experimental process that, in some cases, there was a significant difference between the pump's transient performance and the quasi-steady-state predicted results. This is because rapid starts and stops of the pump lead to fluctuations in pressure and flow rate. Such fluctuations result in the pulse pressure around the blades and the circulation delay behind the blades lagging behind the quasi-steady-state values, causing a difference between the dynamic characteristics of the pump's start-stop process and the quasi-steady characteristics. With the continuous deepening of theoretical research on transient processes, scholars have proposed formulas for predicting the transient head and transient efficiency of blade pumps. By optimizing and adjusting numerical models, accurate simulation and prediction of the pump start-stop process have been achieved. With the development of Computational Fluid Dynamics (CFD), it is possible to optimize the transient performance of blade pumps on this higher precision platform through the full flow field model. Designers can utilize the results of CFD calculations to analyze the internal flow characteristics and improve the transient hydraulic performance of the pump by adjusting structural parameters, but this requires designers to have rich experience related to transient research. Currently, there are few research results on the transient performance of blade pumps both domestically and internationally. The patent with the number CN115199583A, titled “A Blade Design Method for Optimizing Start-Up Transient Performance and Its Designed Blade Pump,” reduces the inlet loss of blades through optimizing the attack angle on the blade inlet edge, improves the pressure distribution at the blade inlet edge, thereby suppressing flow separation, and increases the stable flow rate at the end of start-up. However, this patent does not consider the optimization of other profile parameters or the optimization of the speed change process, which limits the performance improvement.

Meanwhile, scholars have proposed optimization design schemes that combine approximate models with intelligent optimization algorithms based on CFD calculation results. The patent with the number CN103646297A, titled “An Optimization Method of a Double-Suction Pump Based on Multi-Objective Genetic Algorithm,” integrates an artificial neural network model and a multi-objective genetic algorithm. It takes the impeller inlet and outlet diameters, impeller outlet width, flow passage centerline wrap angle, volute base circle diameter, and volute inlet diameter as design variables. With the head, efficiency under rated conditions, and maximum particle passing size as optimization objectives, it improves the design quality of the double-suction pump. The patent with the number CN112784375B, titled “An Optimization Method for High-Efficiency and Low-Pulsation Blade Pump Based on Discrete Genetic Algorithm,” uses the impeller outlet diameter, impeller outlet width, blade outlet chamfer radius, blade inlet and outlet installation angle, and blade wrap angle as optimization parameters. With the pump efficiency and the main frequency amplitude of pressure pulsation at the tongue monitoring point as optimization objectives, it combines a discrete genetic algorithm to optimize the unsteady characteristics of the blade pump. Both patents aim at optimizing the steady-state hydraulic characteristics of the pump, with a relatively simple optimization process and complexity. However, in the transient numerical calculation of CFD during the startup process, a set of transient head and transient efficiency values are output after each time step is completed. Thousands of output results are obtained throughout the entire startup process, resulting in complex data without a systematic solution being proposed yet.

### SUMMARY

Aiming at the shortcomings in the existing technology, the present disclosure proposes a design method for optimizing the transient process performance of a blade pump. Based on a combination of CFD transient numerical calculations, response surface prediction models, and multi-objective optimization algorithms, this method aims to optimize the design of blade pump transient process performance. It proposes improvements for issues such as excessive energy loss, low efficiency, and insufficient head during the startup process of the blade pump.

The technical solution adopted by the present disclosure is as follows:
A design method for optimizing transient process performance of a blade pump, including:
Step 1: creating initial design models for the blade pump and an impeller, as well as a full-flow simulation model of a blade pump startup process; selecting impeller structural parameters as design variables including a blade inlet installation angle, a blade outlet installation angle, a blade wrap angle, a blade thickness, and a blade thickness coefficient;
Step 2: based on the initial design models and the full-flow simulation model of the blade pump startup process created in the Step 1, performing transient numerical calculation on the startup process using CFD simulation software, where transient numerical results include a transient head and a transient efficiency;
Step 3: processing the calculated transient numerical results of the startup process to obtain a weighted average head and a weighted average efficiency;
Step 4: using the design variables as input parameters and the weighted average head and the weighted average efficiency as response values, and establishing a transient process performance optimization model based on a response surface function; and
Step 5: utilizing the established transient process performance optimization model to optimize the transient process performance of the blade pump.

Furthermore, the method for establishing the transient process performance optimization model in the Step 4 includes:
Step 4.1: setting a range for each of the design variables;
Step 4.2: using the design variables as input parameters and the monitored transient head and the transient efficiency as output parameters; setting up a sample collection platform to sample and obtain sample points; processing output parameters to obtain the weighted average head and the weighted average efficiency;
Step 4.3: using the input parameters of the sample points as the design variables and the weighted average head and weighted average efficiency as the response values; selecting the response surface function to establish the transient process performance optimization model;
Step 4.4: evaluating a prediction accuracy of the transient process performance optimization model;
Step 4.5: in a first stage, with G_{z} greater than the weighted average head of an original pump as a constraint and maximizing F_{z} as an objective function, conducting point optimization on the established transient process performance optimization model to obtain multiple predicted points; in a second stage, with H(t)≥H₀(t), η(t)≥η₀(t) as a constraint and maximizing F_{z} as the objective function, optimizing sequentially within the predicted points obtained in the first stage to achieve a final optimization result; and
Step 4.6: utilizing CFX to conduct simulation verification on the impeller model of the blade pump after parameter optimization.

Furthermore, based on ±15% of an initial value of each of the design variables, selecting the range corresponding to each design variable.

Furthermore, the weighted average head is represented as:

$${G}_{z} ( t ) = \frac{{\int }_{0}^{{T}_{tol}} H ( t ) dt}{{T}_{t o l}}$$

and the weighted average efficiency is represented as:

$${F}_{z} ( t ) = \frac{{\int }_{0}^{{T}_{tol}} η ( t ) dt}{{T}_{t o l}}$$

where, t represents the start time; Tₜₒₗ is the total time for flow stability during startup; Δt is the time step; H represents the transient head of the design pump; H₀ represents the transient head of the original pump; η represents the transient efficiency of the design pump; η₀ represents the transient efficiency of the original pump; F_{z} represents the weighted average value of the transient efficiency.

Furthermore, in the Step 4.2, an advanced Latin hypercube sampling method is used to establish sample points.

Furthermore, in the Step 4.4, the sample variance is analyzed and a significance test is conducted on the design variables based on the f-criterion to select parameters that have a significant impact on the response values as optimization variables; sample residuals are analyzed and the performance, adaptability, and prediction accuracy of the response surface model are evaluated based on R-criterion.

Furthermore, f-criterion is represented as:

$${f}_{a} = \frac{{S}_{a} / {E}_{a}}{{S}_{n} / {E}_{n}} ⇒ f ( {E}_{a} , {E}_{n} )$$

where, Sₐ is a sum of squares of deviations of the variables, Sₙ is a sum of squares of deviations caused by experimental errors, Eₐ and Eₙ are degrees of freedom of the design variables and errors, and
the R-criterion consists of three components: R² criterion, R_{adj}² criterion, and R_{pred}² criterion.

Furthermore, the response surface function is selected from a group consisting of a polynomial, a nonlinear function, a power function, a BP neural network model, a radial basis function, or a multivariate adaptive regression spline function.

Furthermore, the modeling method in the Step 1 includes:
Step 1.1: creating the initial design model of the impeller of the blade pump using UG software;
Step 1.2: importing the impeller initial design model created in the Step 1.1 into ANSYS CFturbo through ANSYS Workbench for reverse modeling, where the design variables that need modification are parameterized;
Step 1.3: importing the impeller reverse modeled in the Step 1.2 into ANSYS TurboGrid through ANSYS Workbench to create structured mesh;
Step 1.4: using UG to create a model of the vane pump's guide vane, volute, test pipeline, gate valve, and surge tank; and
Step 1.5: importing the models created in the Step 1.4 into ANSYS ICEM for structured mesh generation.

Furthermore, a thickness distribution between an impeller hub and a shroud is defined as a thickness coefficient θ. When θ<0, a blade thickness extends towards a shroud area, and when θ>0, the blade thickness extends towards a hub area.

The present disclosure has advantages as follows:
(1) By combining the full-flow field calculation of the blade pump startup process with optimization algorithms, the present disclosure seeks the optimal solution for the structural parameters of the blade pump. It provides a reliable design basis for workers lacking rich design experience, thereby enhancing the quality of design.
(2) The training samples of the response surface prediction model in the optimization model are obtained through CFD analysis, while the hydraulic performance of a large number of prediction points generated during the optimization process is predicted by an approximate model. This approach ensures calculation accuracy, significantly accelerates the optimization search process, and reduces the optimization time.

### BRIEF DESCRIPTION OF THE DRAWINGS

FIG. 1 shows a flowchart of a design method for optimizing the transient process performance of a blade pump.

FIG. 2 shows the meridional and 3D view of the impeller.

FIG. 3 shows the distribution diagram of blade thickness.

FIG. 4 shows the simulation model of the full-flow field during the startup process of the blade pump.

FIG. 5 shows the response surface of the weighted average head (Gz)

FIG. 6 shows the response surface of the weighted average efficiency (Fz).

FIG. 7 shows an external characteristic curves of the mixed-flow pump before and after optimization in this embodiment.

### DETAILED DESCRIPTION OF THE EMBODIMENTS

In order to clarify the purpose, technical solution, and advantages of the present disclosure, the following detailed explanation of the present disclosure will be provided, in conjunction with the accompanying figures and embodiments. It should be understood that the specific embodiments described here are only used to explain the present disclosure and not to limit the scope of the present disclosure.

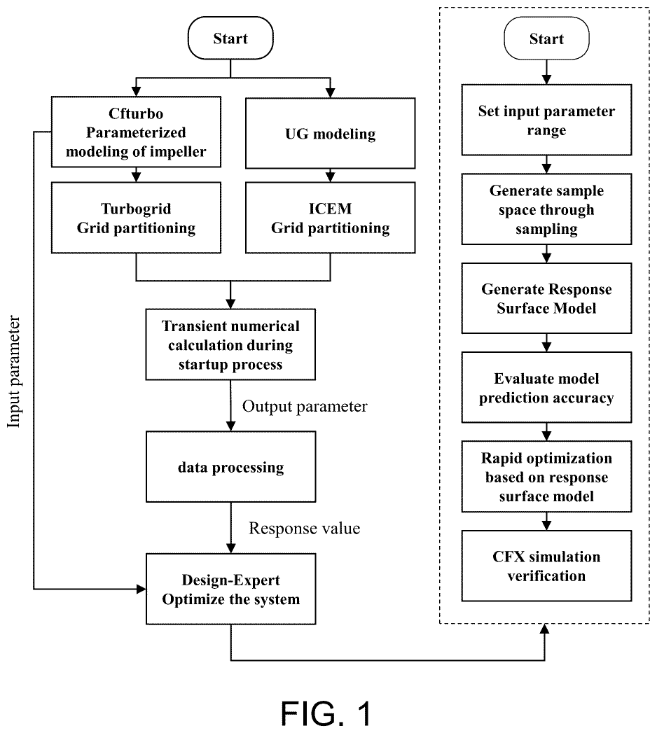

In the design method for optimizing the transient process performance of the blade pump, as shown in FIG. 1, the following steps are included:

Step 1: Utilize simulation software to create the initial design models of the blade pump, impeller, and the full-flow field simulation model of the blade pump startup process.

In this embodiment, the methods for creating the initial design models of the blade pump, impeller, and the full-flow field simulation model of the blade pump startup process are as follows:

Step 1.1: create the initial design model of the impeller for the blade pump using UG.

Step 1.2: import the impeller initial design model created in Step 1.1 into ANSYS CFturbo through ANSYS Workbench for reverse modeling and parameterize the design variables that require modification.

Step 1.3: import the impeller reverse-modeled in Step 1.2 into ANSYS TurboGrid through ANSYS Workbench to generate a structured mesh.

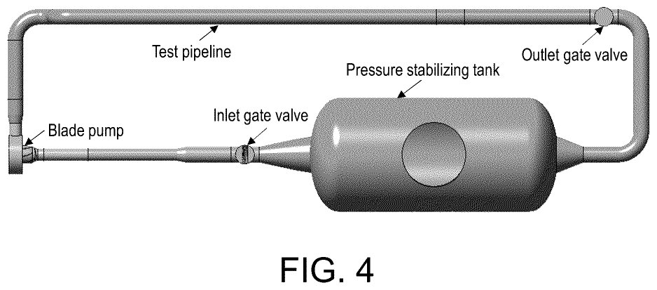

Step 1.4: create models of the blade pump inlet guide vane, volute, test piping, gate valve, and pressure regulating tank using UG. The full-flow field simulation model of the blade pump startup process is shown in FIG. 4.

Step 1.5: import the models created in Step 1.4 into ANSYS ICEM for generating a structured mesh.

In this embodiment, based on the geometric characteristics of the blade pump impeller, significant impeller structural parameters affecting the hydraulic performance of the blade pump are selected as design variables. These include the inlet blade angle, outlet blade angle, blade wrap angle, blade thickness, and blade thickness coefficient. The ranges of these variables are determined based on design experience, generally set at ±15% of the initial values.

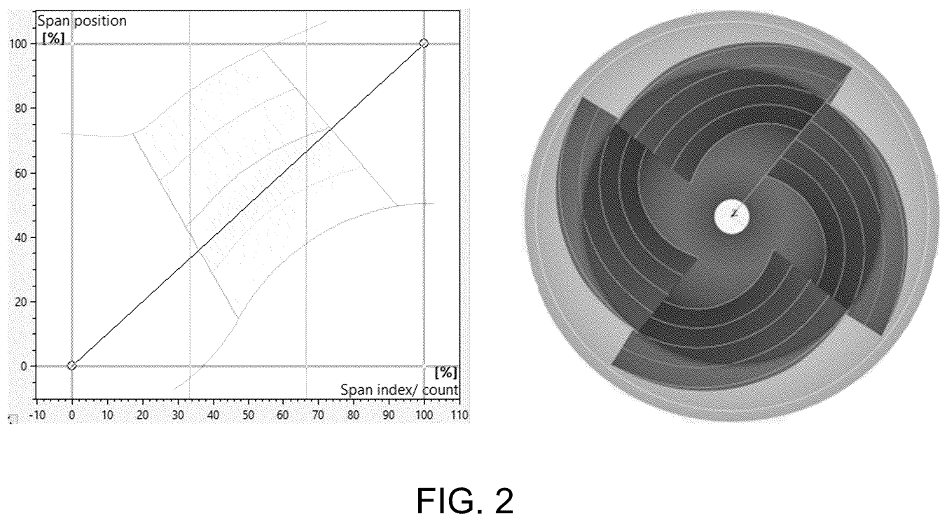

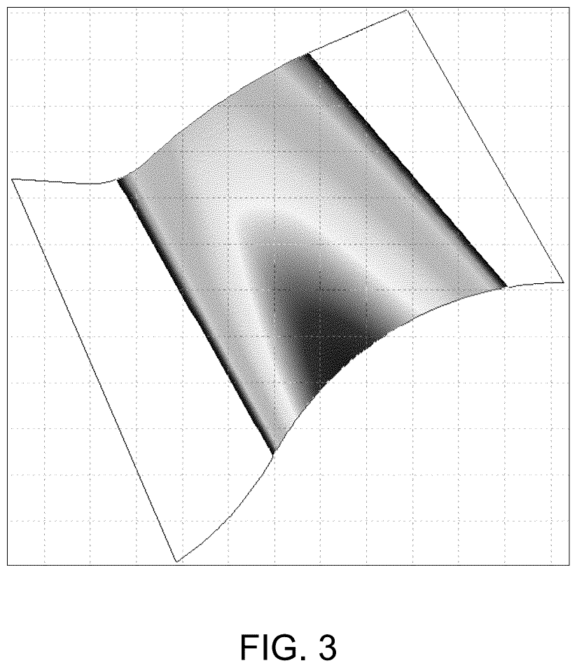

As shown in FIG. 2, the blades are divided into four sections along the span direction. Five spline curves are established at span=0, span=0.25, span=0.5, span=0.75, and span=1.0. Parameters on these spline curves are selected as design variables. Eleven parameters are used to control the blade profile, including the inlet blade angles α₁-α₅, outlet blade angles β₁-β₅, and blade wrap angle φ. Two points are set near the blade leading edge close to the hub and shroud to measure their thickness, defined as ζ₁ and ζ₂. Two points near the blade trailing edge close to the hub and shroud are measured for thickness, defined as ζ₃ and ζ₄. Additionally, the thickness distribution between the blade hub and shroud is defined as the thickness coefficient θ. FIG. 3 shows the blade thickness distribution when θ=0. When θ<0, the blade thickness expands towards the shroud area, and when θ>0, the blade thickness expands towards the hub area.

Step 2: Based on the initial design model and the simulation model of full-flow field during the startup of the blade pump created in Step 1, the transient numerical calculations of the startup process are conducted using CFD simulation software. By analyzing the hydraulic characteristics of the blade pump startup process, the most representative external characteristic parameters are selected as optimization objectives, namely transient head and transient efficiency.

Specifically, the grids generated in Step 1.3 and Step 1.5 are imported into ANSYS CFX to establish the full-flow field simulation model of the blade pump startup process. In the closed-loop model of the full-flow field, the system can simulate the change in flow rate by inputting the fitting formula of the speed for numerical calculations.

The control equations for the transient simulation calculation of the blade pump startup process are established, where the mass conservation equation is:

$$\frac{\partial ρ}{\partial t} + \frac{\partial ( ρ u )}{\partial x} + \frac{\partial ( ρ v )}{\partial y} + \frac{\partial ( ρ w )}{\partial z} = 0 \qquad ( 1 )$$

and the momentum conservation equation is:

$$ρ \frac{\partial {u}_{i}}{\partial t} + {u}_{j} ρ \frac{\partial {u}_{i}}{\partial {x}_{j}} = - \frac{\partial p}{\partial {x}_{i}} + μ \frac{{\partial }^{2} {u}_{i}}{\partial {x}_{j}^{2}} + ρ {f}_{i} \qquad ( 2 )$$

where, ρ is the medium density, t is time, μ Is the dynamic viscosity, p is the fluid element pressure, and fᵢ is the volumetric force.

To accurately simulate the flow transition from laminar to turbulent during the extremely short time of the startup process, particularly focusing on boundary layer separation phenomena in transitional flow, the Detached Eddy Simulation (DES) model is selected as the turbulence model for this transient calculation. In the near-wall region, a limit formula for the turbulence length scale forces the model to switch between RANS and LES to capture the transitional flow phenomena. RANS is used to solve the region near the solid boundary where the turbulent length scale is smaller than the maximum grid size, and LES is employed when the turbulent length scale exceeds the grid size. The expression for the turbulence length scale l in the DES model based on the SST k-ω model is:

$$l = min ( {L}_{t} , {C}_{DES} {Δ}_{max} )$$

where, Lₜ is turbulence length scale, and Lₜ=\sqrt{k}/β*ω, Δₘₐₓ is maximum grid scale, C_{DES} is adaptive parameters.

Using the design variables in ANSYS CFturbo as input parameters and the transient head and efficiency monitored in CFD-Post as output parameters, in conjunction with ANSYS optiSLang, a sample collection platform is established. 150 sample design points are established with the advanced Latin hypercube sampling method and complete transient numerical calculations for the start-up process of the sample points.

Step 3: the transient values calculated during the start-up process are processed to obtain a weighted average head and a weighted average efficiency, respectively, expressed as:
the Weighted Average Head:

$${G}_{z} ( t ) = \frac{{\int }_{0}^{{T}_{tol}} H ( t ) dt}{{T}_{tol}} ;$$

the Weighted Average Efficiency:

$${F}_{z} ( t ) = \frac{{\int }_{0}^{{T}_{tol}} η ( t ) dt}{{T}_{t o l}} ;$$

where, t represents the start time; Tₜₒₗ is the total time for flow stability during startup; Δt is the time step; H represents the transient head of the design pump; H₀ represents the transient head of the original pump; η represents the transient efficiency of the design pump; η₀ represents the transient efficiency of the original pump; F_{z} represents the weighted average value of the transient efficiency.

In Step 4, the transient process performance optimization model is established using the designed variables as input parameters and the weighted average head and efficiency as response values. The process for establishing the transient process performance optimization model includes the following steps:

### Step 4.1: Set the Range for the Input Parameters.

Use the designed variables as input parameters, and the range for each design variable is generally ±15% of its initial value.

### Step 4.2: Sampling and Generating the Sample Space.

Using the designed variables from ANSYS CFturbo as input parameters and the transient head and efficiency monitored in CFD-Post as output parameters, set up a sample collection platform in conjunction with ANSYS optiSLang. Utilize advanced Latin hypercube sampling to establish 150 sample points. Process the output parameters to obtain their weighted average head and efficiency and complete transient numerical simulations for the sample points.

### Step 4.3: Establish the Transient Process Performance Optimization Model.

Use the 150 sample points' input parameters as design variables and the weighted average head and efficiency as response values. Choose response surface functions like polynomials, nonlinear functions, power functions, BP neural network models, radial basis functions, or multivariate adaptive regression splines in Design-Expert software to build the transient process performance optimization model.

### Step 4.4: Evaluate the Prediction Accuracy of the Transient Process Performance Optimization Model.

Analyze the sample variance and conduct significance tests on the design variables based on the f-criterion to identify parameters that significantly impact the response values for optimization. The expression for the f-criterion is:

$${f}_{a} = \frac{{S}_{a} / {E}_{a}}{{S}_{n} / {E}_{n}} ⇒ f ( {E}_{a} , {E}_{n} ) \qquad ( 3 )$$

where, Sₐ represents the sum of squares of deviations for each variable, Sₙ is the sum of squares of deviations caused by experimental errors, Eₐ and Eₙ denote the degrees of freedom for the design variables and deviations. By setting the significance level critical value to 0.05, when f≥f_{1-0.05}(Eₐ, Eₙ), i.e., P≤0.05, the influence of that variable is considered significant; when f≤f_{1-0.05}(Eₐ, Eₙ), i.e., P≥0.05, the influence of that variable is considered not significant.

Analyze the sample residuals and conduct a comprehensive evaluation of the performance, fitting range, and prediction accuracy of the response surface model based on the R-criterion. The R-criterion is a model selection criterion consisting of R² criterion, R_{adj}² criterion, and R_{pred}² criterion. It is utilized to determine which linear regression model is more suitable for describing a given dataset among multiple linear regression models.

$${R}^{2} = 1 - \frac{S {S}_{E}}{S {S}_{T}} ( 0 \leq {R}^{2} \leq 1 ) \qquad ( 4 )$$

$${R}_{adj}^{2} = 1 - \frac{{SS}_{E} / {d}_{E}}{{SS}_{T} / {d}_{T}} = 1 - \frac{{d}_{T}}{{d}_{E}} ( 1 - {R}^{2} ) \qquad ( 5 )$$

$${R}_{p r e d}^{2} = 1 - \frac{P R E S S}{S {S}_{T}} \qquad ( 6 )$$

where, SS_{E} represents the variance of the design variables; SS_{T} stands for the total variance of the model; d_{E} denotes the degrees of freedom for the design variables, and d_{T} represents the total degrees of freedom of the model; PRESS denotes the sum of squared prediction errors.

When the values of R² and R_{adj}² are both greater than 0.9, and the difference between R_{pred}² and R_{adj}² is less than 0.2, it indicates a high fitting accuracy of the response surface model. This suggests that the model can effectively express the underlying relationship between input parameters and response values, making it suitable for subsequent optimization and solution tasks.

### Step 4.5: Rapid Optimization Based on the Transient Process Performance Optimization Model.

Propose optimization plan objective function and constraints:

$$H ( t ) \geq {H}_{0} ( t ) \qquad ( 7 )$$

$$η ( t ) \geq {η}_{0} ( t ) \qquad ( 8 )$$

$${F}_{z} ( t ) = \frac{{\int }_{0}^{{T}_{tol}} η ( t ) dt}{{T}_{t o l}} \to max \qquad ( 9 )$$

In the first stage, with the constraint of G_{z} greater than the original pump weighted average head and maximizing F_{z} as the objective function, perform point optimization on the established transient process performance optimization model. Obtain 100 predicted points that satisfy the constraint, arranged in descending order of predicted F_{z} values.

In the second stage, with H(t)≥H₀(t), η(t)≥η₀(t) as a constraint and maximizing F as the objective function, optimize sequentially within the predicted points obtained in the first stage to achieve the final optimization result.

### Step 4.6: CFX Simulation Verification

Validate the results of intelligent optimization by utilizing the optimized blade pump parameters to establish an optimized impeller model. Import this model into the CFX full-flow field model for numerical simulations during the startup process. Conduct a comparative analysis between the numerical results of the optimized model and the predicted results of the response surface model to verify the prediction accuracy of the model. Additionally, compare the numerical results of the optimized model with the initial model to validate the effectiveness of the optimization method.

### Step 5: Utilize the Established Transient Process Performance Optimization Model to Optimize the Transient Process Performance of the Blade Pump.

To illustrate the technical solution of the present disclosure clearly, take a mixed-flow pump with a rated speed of n=1450 r/min, a rated flow rate of Q=480 m³/h, a rated head of H=6 m, and a blade number of z=4 as an example. The axial projection of the pump is shown in FIG. 2. The present disclosure method maintains the unchanged values of the impeller inlet width b₁, impeller outlet width b₂, impeller inlet diameter D₁, and the number of blades z. Detailing the optimization design process for the transient process performance of the pump, the specific procedure is as follows:

As shown in Table 1 are the defined optimization design parameters and their ranges of variation. Utilize the structural parameters of the original pump to establish an initial model through UG, and create a full-flow field model for the startup process of the mixed-flow pump as shown in FIG. 3. Import the original pump model into CFturbo for reverse modeling and further import the obtained model into TurboGrid to create high-quality structured grids as shown in FIG. 4. Input the impeller mesh and other flow components into ANSYS Workbench and then into ANSYS CFX for numerical simulation of the mixed-flow pump's startup process, monitoring the transient efficiency η and transient head H during the startup process. In this example, the mixed-flow pump adopts a linear startup method with constant acceleration, taking 1.35 s to reach a speed of 1450 r/min from zero. The total startup time is set to be 2.5 s when the flow rate stabilizes, with a time step of 0.001 s. Throughout the transient calculation process of the startup, each time step will output a set of transient head and efficiency values, totaling 2500 data sets at the end of the 2.5 s calculation.

TABLE 1

| | | | |
|---|---|---|---|
| Design | | Initial | |
| parameters | Unit | value | Variable range |

| | | | | | |
|---|---|---|---|---|---|
| Blade inlet | α₁ | ° | 40.9 | 35.9 | 45.9 |
| placement | α₂ | ° | 35.0 | 30.0 | 40.0 |
| angle | α₃ | ° | 29.0 | 25.0 | 33.0 |
| | α₄ | ° | 23.1 | 19.1 | 27.1 |
| | α₅ | ° | 17.1 | 14.1 | 20.1 |
| Blade outlet | β₁ | ° | 33.3 | 28.3 | 38.3 |
| placement | β₂ | ° | 28.0 | 23.0 | 33.0 |
| angle | β₃ | ° | 22.6 | 16.6 | 26.6 |
| | β₄ | ° | 17.3 | 13.3 | 21.3 |
| | β₅ | ° | 11.9 | 8.9 | 14.9 |
| Blade wrap | φ | ° | 90 | 85 | 95 |
| angle | | | | | |
| Blade | ζ₁ | mm | 2.6 | 2.1 | 3.1 |
| thickness | ζ₂ | mm | 2.6 | 2.1 | 3.1 |
| | ζ₃ | mm | 2.6 | 2.1 | 3.1 |
| | ζ₄ | mm | 2.6 | 2.1 | 3.1 |
| Blade | θ | / | 0 | −1 | 1 |
| thickness | | | | | |
| coefficient | | | | | |

Using the 16 design variables shown in Table 1 as input parameters, the transient head H and transient efficiency η monitored in CFD-Post are the output parameters. By combining with ANSYS optiSLang, an advanced Latin Hypercube sampling method is employed to establish 150 sample design points and complete transient numerical calculations for the startup process at these sample points. A weighted average formula for head and efficiency is established in Excel to preprocess the transient head and efficiency data.

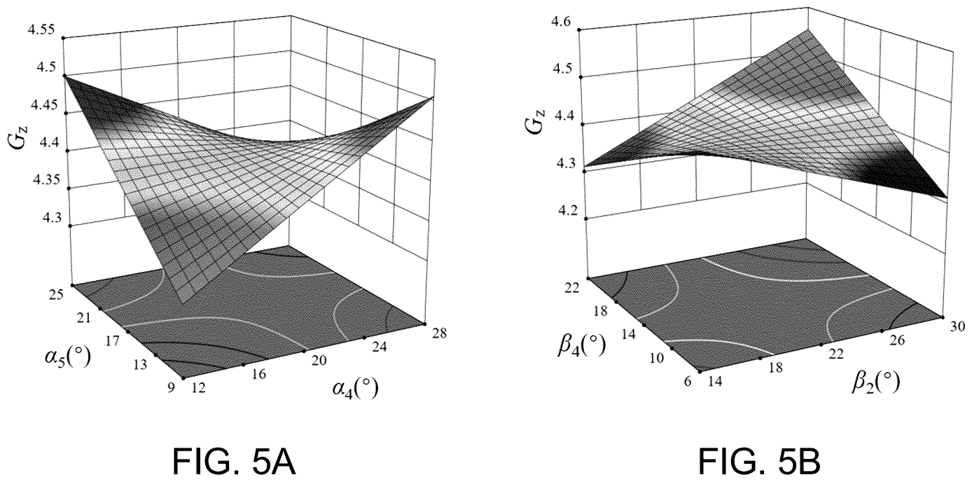

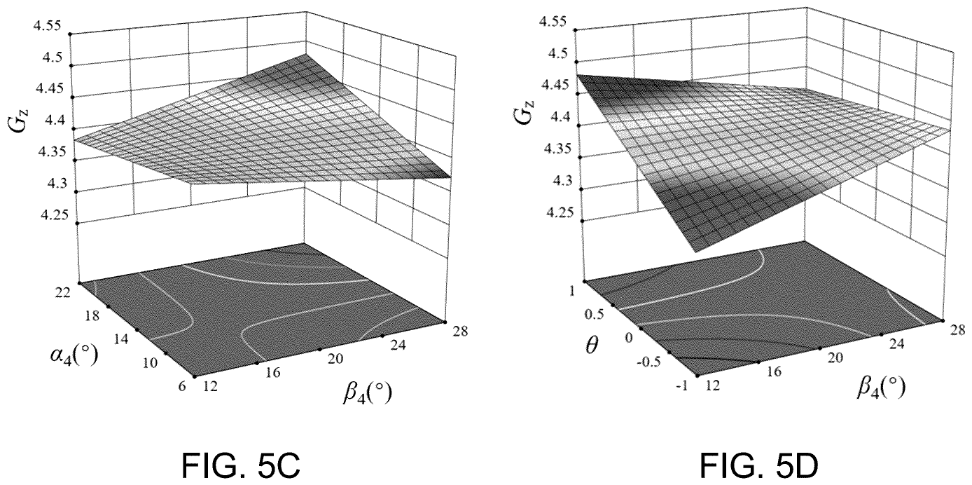

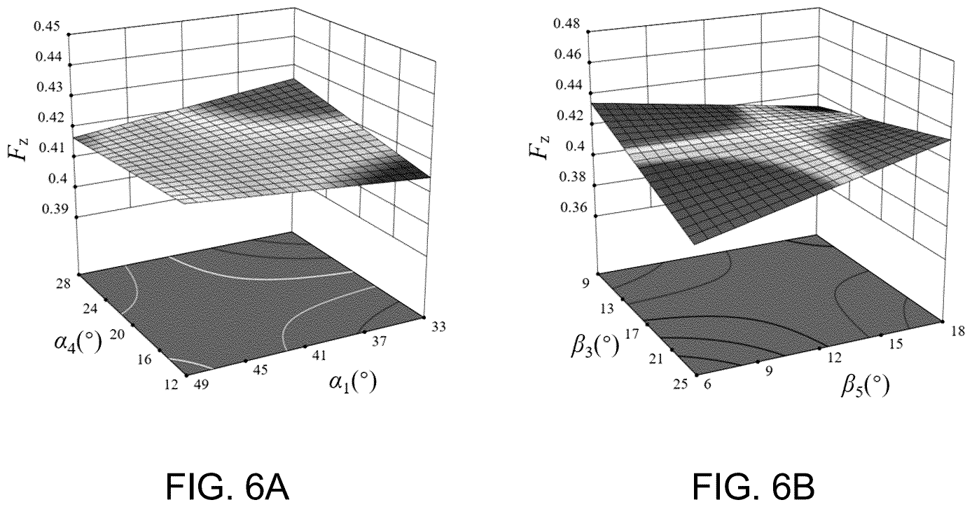

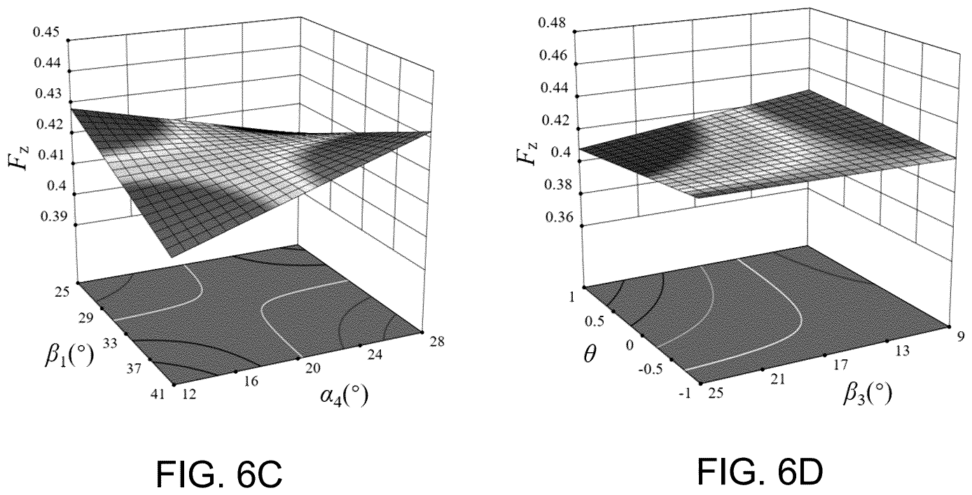

In Design-Expert, a Central Composite Design (CCD) with 10 factors is established. Two response values, G_{z} and F_{z}, are set. The data processed in Excel is then input correspondingly into the generated design table. After conducting a significance test, it was found that the effects of the blade inlet angles α₂, α₃, and blade thickness on the weighted average head and efficiency were low. Therefore, these parameters were excluded from the optimization variables. A response surface model was then established with the remaining 10 design variables and 2 response values, as shown in FIGS. 5 and 6. The precision test of the response surface model yielded Table 2, indicating that the R² and R_{adj}² values of each response surface model are greater than 0.9, with the difference between R_{pred}² and R_{adj}² being less than 0.2. This demonstrates a high fit accuracy of the response surface models, effectively expressing the inherent relationship between input parameters and response values. The established response surface model can be utilized for subsequent optimization and solving tasks.

TABLE 2

| | G_{z} | F_{z} |
|---|---|---|
| R² | 0.9794 | 0.9634 |
| R_{adj}² | 0.9686 | 0.9753 |
| R_{pred}² | 0.8231 | 0.9762 |

In first optimization stage, the optimization condition is set as having G_{z} greater than the original pump's weighted average head as the constraint and maximizing F_{z} as the objective function. In second optimization stage, the optimization condition is set as having H(t) ≥H₀(t), η(t)≥η₀(t) as the constraint and maximizing F_{z} as the objective function. After undergoing optimization in two stages, the final optimized results are presented in Table 3.

TABLE 3

| Parameters | α₁/° | α₄/° | α₅/° | β₁/° | β₂/° | β₃/° | β₄/° | β₅/° | φ/° | θ |
|---|---|---|---|---|---|---|---|---|---|---|
| Original | 40.9 | 23.1 | 17.1 | 33.3 | 28.0 | 22.6 | 17.3 | 11.9 | 90 | 0 |
| Optimize pump II | 31.0 | 10.0 | 27.0 | 23.3 | 31.8 | 27.0 | 14.0 | 21.5 | 93 | −0.277 |

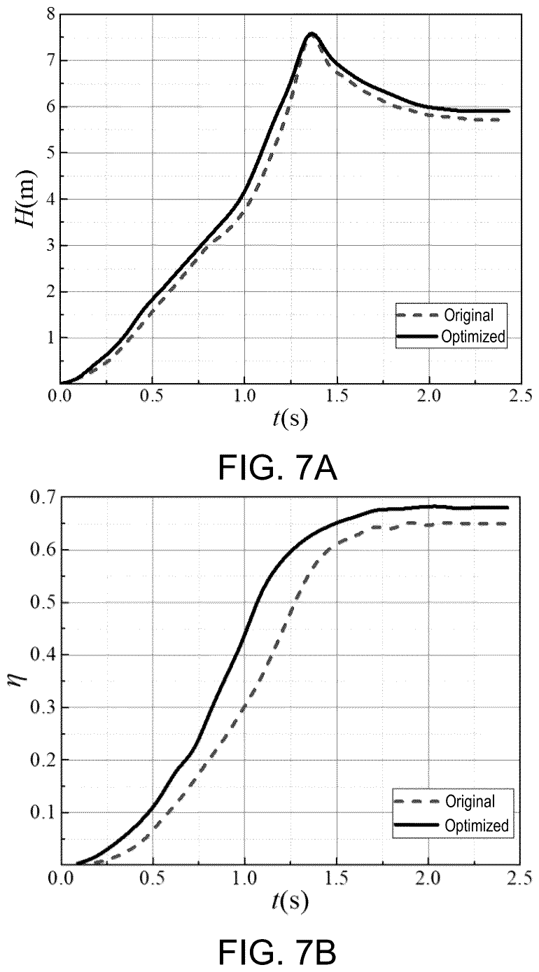

After verification through CFX simulation, the optimized mixed-flow pump results in Table 4. It can be observed from the table that the weighted average efficiency of the mixed-flow pump during the transient startup process has increased by 8.91% overall, while the weighted average head has increased by 2.97%. The rated head has risen by 3.51%, and the rated efficiency has increased by 5.08%. The external characteristic curves of the mixed-flow pump before and after optimization during the startup process are shown in FIG. 7. It is evident from the graph that at each moment, the transient head and efficiency of the optimized pump are higher than those of the original pump, thus achieving the expected optimization goals.

TABLE 4

| | Original | Forecast | Validate | Effect |
|---|---|---|---|---|
| G_{z} | 4.37 | 4.53 | 4.50 | 2.97%↑ |
| F_{z} | 0.4220 | 0.4608 | 0.4596 | 8.91%↑ |
| H_{d} | 5.70 | / | 5.95 | 3.51%↑ |
| η_{d} | 0.649 | / | 0.682 | 5.08%↑ |

The above example is only intended to illustrate the design concept and characteristics of the present disclosure. Its purpose is to enable those skilled in the art to understand the content of the present disclosure and perform implementation. The scope of protection of the present disclosure is not limited to the above embodiments. Therefore, any equivalent changes or modifications made based on the principles and design ideas disclosed by the present disclosure fall within the scope of protection of the present disclosure.

1. A design method for optimizing a transient process performance of a blade pump, comprising:
Step 1: creating initial design models for the blade pump and an impeller, as well as a full-flow simulation model for a blade pump startup process; selecting impeller structural parameters as design variables comprising a blade inlet installation angle, a blade outlet installation angle, a blade wrap angle, a blade thickness, and a blade thickness coefficient;
Step 2: based on the initial design models and the full-flow simulation model for the blade pump startup process created in the Step 1, performing transient numerical calculation on a startup process using a CFD simulation software, wherein transient numerical results comprise a transient head and a transient efficiency;
Step 3: processing the calculated transient numerical results of the startup process to obtain a weighted average head and a weighted average efficiency;
Step 4: using the design variables as input parameters and the weighted average head and the weighted average efficiency as response values, and establishing a transient process performance optimization model based on a response surface function; and
Step 5: utilizing the transient process performance optimization model to optimize the transient process performance of the blade pump.

2. The design method for optimizing the transient process performance of the blade pump according to claim 1, wherein a method for establishing the transient process performance optimization model in the Step 4 comprises:
Step 4.1: setting a range for each of the design variables;
Step 4.2: using the design variables as the input parameters and the monitored transient head and the transient efficiency as output parameters; setting up a sample collection platform to sample and obtain sample points; processing the output parameters to obtain the weighted average head and the weighted average efficiency;
Step 4.3: using the input parameters of the sample points as the design variables and the weighted average head and weighted average efficiency as the response values; selecting the response surface function to establish the transient process performance optimization model;
Step 4.4: evaluating a prediction accuracy of the transient process performance optimization model;
Step 4.5: in a first stage, with G_{z} greater than the weighted average head of an original pump as a constraint and maximizing F_{z} as an objective function, conducting point optimization on the established transient process performance optimization model to obtain multiple predicted points; in a second stage, with H(t)≥H₀(t), η(t)≥η₀(t) as the constraint and the maximizing F_{z} as the objective function, optimizing sequentially within the predicted points obtained in the first stage to achieve a final optimization result; and Step 4.6: utilizing CFX to conduct simulation verification on a impeller model of the blade pump after parameter optimization.

3. The design method for optimizing the transient process performance of the blade pump according to claim 2, wherein select a range corresponding to the each of the design variable based on ±15% of an initial value of the each of the design variables.

4. The design method for optimizing the transient process performance of the blade pump according to claim 2, wherein the weighted average head is represented as:
$${G}_{z} ( t ) = \frac{{\int }_{0}^{{T}_{t o l}} H ( t ) d t}{{T}_{tol}}$$
and the weighted average efficiency is represented as:
$${F}_{z} ( t ) = \frac{{\int }_{0}^{{T}_{t o l}} η ( t ) d t}{{T}_{tol}}$$
wherein, t represents a start time; Tₜₒₗ is a total time for flow stability during startup; Δt is a time step; H represents the transient head of a design pump; H₀ represents the transient head of the original pump; η represents the transient efficiency of the design pump; η₀ represents the transient efficiency of the original pump; F_{z} represents the weighted average value of the transient efficiency.

5. The design method for optimizing the transient process performance of the blade pump according to claim 2, wherein in the Step 4.2, an advanced Latin hypercube sampling method is used to establish the sample points.

6. The design method for optimizing the transient process performance of the blade pump according to claim 2, wherein in the Step 4.4, a sample variance is analyzed and a significance test is conducted on the design variables based on a f-criterion to select parameters that have a significant impact on the response values as optimization variables; sample residuals are analyzed and a performance, adaptability, and prediction accuracy of a response surface model are evaluated based on a R-criterion.

7. The design method for optimizing the transient process performance of the blade pump according to claim 6, wherein an expression for the f-criterion is:
$${f}_{a} = \frac{{S}_{a} / {E}_{a}}{{S}_{n} / {E}_{n}} ⇒ f ( {E}_{a} , {E}_{n} )$$
wherein, Sₐ is a sum of squares of deviations of the design variables, Sₙ is a sum of squares of deviations caused by experimental errors, Eₐ and Eₙ are degrees of freedom of the design variables and errors, and the R-criterion consists of three components: R² criterion, R_{adj}² criterion, and R_{pred}² criterion.

8. The design method for optimizing the transient process performance of the blade pump according to claim 2, wherein the response surface function is selected from a group consisting of a polynomial, nonlinear function, a power function, a BP neural network model, a radial basis function, or a multivariate adaptive regression spline function.

9. The design method for optimizing the transient process performance of the blade pump according to claim 8, wherein a modeling process in the Step 1 comprises:
Step 1.1: creating an initial design model of the impeller of the blade pump using UG software;
Step 1.2: importing the initial design model of the impeller created in the Step 1.1 into ANSYS CFturbo through ANSYS Workbench for reverse modeling, wherein the design variables that need modification are parameterized;
Step 1.3: importing the impeller reverse modeled in the Step 1.2 into ANSYS TurboGrid through ANSYS Workbench to create a structured mesh;
Step 1.4: using UG to create a model of the vane pump's guide vane, volute, test pipeline, gate valve, and surge tank; and
Step 1.5: importing the models created in the Step 1.4 into ANSYS ICEM for structured mesh generation.

10. The design method for optimizing the transient process performance of the blade pump according to claim 8, wherein a thickness distribution between an impeller hub and a shroud is defined as a thickness coefficient θ, when θ<0, a blade thickness extends towards a shroud area, and when θ>0, the blade thickness extends towards a hub area.
